(19) United States
(12) Patent Application Publication
(10) Pub. No.: US 2018/0224344 A1
(43) Pub. Date: Aug. 9, 2018

(54) DIFFERENTIAL PRESSURE TRANSDUCER

(71) Applicant: EEE Anlagenbau GmbH, Furstenwalde (DE)

(72) Inventors: Martin Scholich, Fürstenwalde (DE); Marko Bartusch, Fürstenwalde (DE); Guido Aglaster, Werder/Havel (DE)

(73) Assignee: EEE Anlagenbau GmbH, Furstenwalde (DE)

(21) Appl. No.: 15/889,139

(22) Filed: Feb. 5, 2018

(30) Foreign Application Priority Data
Feb. 6, 2017 (DE) 10 2017 001 049.8

(51) Int. Cl. G01L 7/18; G01L 27/00; G01L 19/00; G01F 1/40; G01F 1/68

(52) U.S. Cl. CPC G01L 7/182; G01L 27/002; G01F 1/68; G01F 1/40; G01L 19/0007

(57) ABSTRACT

A differential pressure transducer is provided, having a tubular housing disposed between first and second connection elements. The housing includes an inflow section, a diffuser section, a constrictor section and an outflow section. The inflow section and the outflow section each have a flow cross-section with a first inner diameter. In the direction of fluid flow, the diffuser section has an inner diameter that continuously increases up to a second inner diameter, while the constrictor section has an inner diameter that continuously decreases down to the first inner diameter. An equalization tube is connected between the first connection element and the inflow section of the housing. A quotient of an inner length and an inner diameter of the equalization tube is at least 2.5. A plurality of openings extend through the housing and are fitted with coupling elements for connection to impulse lines or sensors.

### CROSS-REFERENCE TO RELATED APPLICATION(S)

This application claims priority under 35 U.S.C. § 119 to German Patent Application No.: 10 2017 001 049.8, filed on Feb. 6, 2017, which is herein incorporated by reference.

### TECHNICAL FIELD

The disclosure relates to a differential pressure transducer with a tubular housing, which is arranged between a first and a second connection element, wherein it is provided that a fluid flows in through the first connection element to the housing and flows out through the second connection element, wherein the housing looking in the flow direction of the fluid at first comprises an inflow section with a first flow cross section, followed by a diffuser section with a flow cross section increasing continuously up to a second flow cross section, followed by a constrictor section with a flow cross section decreasing continuously up to the first flow cross section, and followed by an outflow section having the first flow cross section, wherein there is arranged at the circumference of the housing in the inflow section or in the outflow section at least a first pressure decrease recess, wherein on the circumference of the housing in the region of the second flow cross section there is arranged at least a second pressure decrease recess.

### BACKGROUND

It is generally known how to employ differential pressure transducers to determine the volume flow of fluids, i.e., gases or liquids. The most commonly used construction of differential pressure transducers is based on at first narrowing the cross section of a medium flowing in a pipeline, thereby accelerating the flowing medium in this manner. The pressures in the fluid flow in the original pipeline cross section and in the narrowed cross section are measured and the volume flow is derived from this. By an additional measurement of process variables, such as the temperature, and given a known material composition of the fluid, it is also possible to calculate the mass flow of the fluid. Customary constructions for this kind of differential pressure transducer are metering orifices, metering nozzles, or Venturi tubes. Each of these designs has various drawbacks. For example, a metering orifice affords a relatively high measurement accuracy, but causes a relatively large unwanted pressure drop in the fluid. When using metering nozzles, the pressure loss in the fluid is reduced as compared to the metering orifices, but the achievable measurement accuracy is relatively worse than that of metering orifices. With a Venturi tube, the pressure loss is relatively slight, but one must accept a relatively poor measurement accuracy with this measurement principle.

From DE 196 48 588 C1 there is known a differential pressure transducer with a totally different design, in which the diameter of the measurement section at first increases from the diameter of an inflow side, i.e., the fluid is at first slowed down. After the widening of the diameter of the metering device, the diameter is again reduced to an outflow diameter. In this differential pressure transducer, pressures are measured at metering circumferences at the inflow side, the outflow side, and at the circumference of the largest diameter. The proposed differential pressure transducer has a plurality of boreholes in the different measurement levels, which connect the internal region of the differential pressure transducer to a pressure metering channel belonging to the differential pressure transducer housing in the corresponding measurement level for pressure equalization. The pressure in the measurement level is then measured only in a borehole in the respective pressure metering channel. These design features result in an indirect pressure measurement of the differential pressure transducer's internal pressure by the measurement of the pressure in a pressure metering channel. The drawback here is that the differential pressure transducer has a relatively complicated construction and the plurality of boreholes need to be protected against fouling with dirt particles carried along by the fluid. This protection is afforded by a cylindrical protection insert. Furthermore, it is a drawback that the protection insert causes an unwanted pressure loss, which further increases the pressure loss of the differential pressure transducer.

Starting from this prior art, the problem which the disclosure proposes to solve is to describe a differential pressure transducer having an especially slight pressure loss.

### SUMMARY

A differential pressure transducer is provided through which fluid may flow. The differential pressure transducer includes a tubular housing disposed between first and second connection elements and arranged such that fluid flows in through the first connection element to the housing and flows out through the second connection element. The housing, as viewed in the direction of fluid flow, includes an inflow section with a first flow cross-section. A diffuser section follows the inflow section and has a flow cross-section increasing continuously up to a second flow cross section. A constrictor section follows the diffuser and has a flow cross-section decreasing continuously down to the first flow cross section. An outflow section follows the constrictor and has the first flow cross section. The housing, at its circumference, has at least a first pressure decrease recess in the inflow section or in the outflow section and at least a second pressure decrease recess in the vicinity of the second flow cross section. An equalization tube is connected between the first connection element and the inflow section of the housing. The equalization tube has an inner length and an inner diameter. A quotient of the inner length and the inner diameter is at least 2.5.

### BRIEF DESCRIPTION OF THE DRAWINGS

The disclosure, further embodiments and further advantages are to be described in greater detail using the exemplary embodiments which are shown in the drawings, in which:

FIG. 1 shows a first exemplary differential pressure transducer in a cross section view;

FIG. 2 shows the first exemplary differential pressure transducer in a 3D view; and

FIG. 3 shows a second exemplary differential pressure transducer as a sketch.

### DETAILED DESCRIPTION OF ILLUSTRATIVE EMBODIMENTS

This disclosure describes a differential pressure transducer of the type described in the introduction that has a small pressure loss. The differential pressure transducer is characterized in that between the first connection element and the inflow section there is arranged an equalization tube, and in that a ratio between an equalization tube length of the equalization tube and an inner dimension of the tube is at least 2.5.

The basic idea of the disclosure is to provide a differential pressure transducer whose flow-conducting components have the least possible pressure loss. For this, the installation of components causing pressure losses in the flow of fluid in the internal flow region of the differential pressure transducer is avoided. In this way, the pressure loss due to the differential pressure transducer according to the invention is minimized. By fluid is meant here a gaseous, a liquid, or a vaporized medium. According to the prior art, installed pieces are always required in the internal region of the differential pressure transducer, for example in order to influence the flow of the medium for a sufficiently good measurement quality, or to prevent a fouling of a plurality of holes for the indirect pressure measurement in the wall of the housing of the differential pressure transducer by a protective screen.

Furthermore, it has been found that by arranging the equalization tube upstream from the housing in the flow direction, the flow can be favourably influenced so that a measurement accuracy is achievable which can be calibrated and standardized. Furthermore, it has been found that, depending on the fluid, a measurement quality sufficient for calibration is already achievable with a ratio of a tube length of the equalization tube to a tube inner dimension of 2.5. With a ratio of 3, the measurement quality is further improved. If the ratio is between 4 and 6, an optimal measurement quality is achieved at the same time as a minimal pressure loss caused by the equalization tube. With a ratio larger than 6, there is no noticeable improvement in the measurement accuracy or the measurement quality, while the pressure loss increases accordingly due to a correspondingly longer equalization tube.

The flow cross sections in the first and second connection element, in the equalization tube and in the housing may have fundamentally different shapes, for example, circular, elliptical, square, rectangular, hexagonal, trapezoidal or some other shape. The inner dimension or tube inner dimension should be a dimension typical of the flow cross section, for example, for a piece of tubing with circular flow cross section the tube inner dimension is the inner diameter of the tube, for a tube with square or rectangular flow cross section the tube inner dimension is the diagonal of the cross section of the tube interior, for a tube with a polygonal flow cross section the tube inner dimension is likewise a diagonal of the cross section of the tube interior, and for a tube with a trapezoidal flow cross section the tube inner dimension is likewise the diagonal of the flow cross section.

Thanks to the arranging of an equalization tube and a housing between a first and a second connection element to a differential pressure transducer, its design is also advantageously simplified. A further improvement in the differential pressure transducer according to the invention is that the pressure decrease recesses are configured such that a pressure measurement is taken directly at them. An otherwise necessary pressure equalization by a plurality of pressure metering holes and an additional pressure metering annular space is avoided.

The differential pressure transducer according to the invention can be adapted for installation in pipelines of different tube inner dimensions, such as diameter. The differential pressure transducer in theory can be installed in all pipeline inner dimensions, such as round pipes starting with a tube inner dimension, namely, a diameter of 1 mm. Furthermore, the especially simple design starting with a rated diameter of DN80 proves to be particularly advantageous, since the manufacture of small differential pressure transducers of every kind is relatively simple, but the fabrication expense increases disproportionately with the rated diameter. Thus, the fabrication of differential pressure transducers according to the invention in sizes of DN300, DN500 or DN1000 can be realized rather easily with simple basic bodies and no installed parts. The otherwise customary exactly fitted installed parts of other kinds of differential pressure transducers, such as screens or flow straighteners, on the other hand, require correspondingly disproportionately large fabrication expense especially for large rated diameters.

For a pressure metering it is enough to provide precisely one first and precisely one second pressure decrease recess. But there are also applications for the differential pressure transducer in which, for example, several independent metering sites are desirable for a pressure metering, for reasons of redundancy. In that case, 2, 3 or even 4 first and/or second pressure decrease recesses are distributed over the circumference of the housing in the respective housing section, i.e., in the inflow section, in the outflow section or in the housing section with the largest flow cross section—the second flow cross section. In this way, one can achieve redundancies of, for example, 1 out of 2, 2 out of 3 or 3 out of 4.

According to the disclosure, it is also provided that there is arranged at least one third pressure decrease recess in the differential pressure transducer in the inflow section or in the outflow section, so that the inflow section and the outflow section comprise either the at least one second or the at least one third pressure decrease recess.

In this way, it is ensured that at least one pressure decrease recess is present both in the inflow section and in the outflow section. In this way, a redundancy in the pressure metering is made possible. Furthermore, comparison measurements can be taken between inflow section and outflow section, as well as various differential pressure formations, namely, the differential pressure between the pressure at the second and the first pressure decrease recess or between the pressure at the second and the third pressure decrease recess.

A modification of the differential pressure transducer according to the invention is characterized in that a quotient of a maximum inner dimension of the housing to a first inner dimension of the inflow section is at least 1.2 and at most 2.5, but ideally 1.5. The second or maximum inner dimension here is the inner dimension of the second flow cross section and the first inner dimension is the inner dimension of the first flow cross section.

A further improvement in the differential pressure transducer is achieved if an internal region of the housing has the above-described quotient. This ensures that an intersection of the envelope surface of an internal face of the differential pressure transducer with a plane perpendicular to each point along an imaginary centre line along its longitudinal extension, i.e., along the first connection element, the equalization tube, the housing and the second connection element is circular each time. In this way, the flow cross section present at each of these points along the imaginary centre line can be indicated or calculated by the respective inner diameter at this point.

Especially advantageous flow conditions for the pressure measurements obtain when the ratio between the second inner dimension, which is the maximum inner dimension, and the first inner dimension is 1.5.

Furthermore, it is proposed to configure the differential pressure transducer according to the invention such that a quotient of a length of the diffuser section to a length of the constrictor section, looking in the flow direction, is at least 1 and at most 5, preferably 3.7.

With this feature, it is possible to influence the flow through the housing and in this way to influence advantageously the flow conditions for the pressure measurements. It has been found to be advantageous to the quality of the pressure metering when the aforementioned quotient takes on a value of roughly 3.7. When the quotient takes on the value 1, the diffuser section and the constrictor section are of equal length. In this case, the possibility exists of the differential pressure transducer according to the invention being suitable for a bidirectional continuous flow, i.e., for a measurement of flow in both possible directions by the differential pressure transducer. In the other cases, the flow is only provided in one direction.

Furthermore, it is of advantage for the differential pressure transducer to be designed such that the quotient of the second inner dimension of the housing and the length of the diffuser section is at least 0.3 and at most 0.5. With this configuration as well the flow can be influenced for a better quality of measurement of the pressure metering.

Another configuration of the differential pressure transducer proposes that a metering section is interposed between the diffuser section and constrictor section, comprising the second inner dimension and having a metering section length whose maximum lengthwise dimension corresponds to the value of half of the first inner dimension.

In this way, a metering section of the housing is provided with a constant second inner dimension, with which it is possible in especially simple manner to arrange the at least one second pressure decrease recess. The at least one second pressure decrease recess may then, in fact, be arranged on the entire length of the metering section on its circumference, and not only in the area of the transition between the constrictor section and diffuser section, which enhances the flexibility of the arrangement of the pressure decrease recess.

One modification of the differential pressure transducer is characterized in that at least one of the at least first, at least second, or at least third pressure decrease recesses is configured as a coupling recess, so that this is suitable for connecting of a coupling element or for introducing of sensors for visual monitoring, geometrical surveying, or calibration of the metrologically relevant region of the interior of the housing.

In this way, on the one hand it is accomplished that the pressure metering continues to occur immediately at the pressure decrease recess. On the other hand, the coupling recess is suitable for putting in place other metered value recorders when necessary, or is configured for the introduction of sensors.

Another technical alternative of the differential pressure transducer proposes that the at least one coupling recess is connected to a coupling element, having a first and/or a second connection recess for a pressure metering sensor or a differential pressure line of a pressure metering device or suitable for the connection or introduction of sensors.

With a coupling element, for example, standardized pressure metering lines are especially easy to connect and furthermore an immediate pressure metering is made possible at the pressure decrease recess. Furthermore, the coupling element makes possible other technical functions as needed. For example, a coupling element with two connection recesses makes possible, on the one hand, the connecting of a differential pressure line to a first connection recess and on the other hand the introducing of a metering sensor via a second connection recess into the interior of the housing. A special advantage then is that the differential pressure line does not have to be dismounted before introducing the sensor.

One advantageous embodiment of the differential pressure transducer with coupling elements proposes that one connection recess can be welded or glued shut or closed up by an external threaded cap, an internal threaded plug, a flange cover, a clamp cover or some other closure element. In this way, a connection recess can be closed up especially easily if it is temporarily not required.

The differential pressure transducer is also characterized in that the connection element is connected to an equalization device, with which the free volume in the differential pressure line can be changed. In this way, it is particularly easily possible to prevent measurement perturbations in the respective differential pressure line, such as oscillations or fluctuations of the fluid in the differential pressure line, by reducing the free volume.

Furthermore, it is also proposed for the differential pressure transducer that the connection element is connected to a cleaning device, with which the pressure decrease recess connected to the connection element may be cleaned if needed. Thanks to such a cleaning device, the pressure decrease recess may be cleaned, for example, with a mechanical cleaning element, with pressurized air or pressurized air pulses, or with ultrasound. Such a cleaning device is especially expedient when the fluid is laden with corresponding foreign particles or dirt. The cleaning itself is done either when needed or by cycles at preestablished intervals of time.

Furthermore, the disclosure relates to a flow metering device with a differential pressure transducer according to the invention, wherein a respective pressure at the pressure decrease recesses is measurable by pressure transducers, possibly with the interposing of pressure metering lines and/or coupling elements, wherein the temperature of the fluid is measurable with a temperature metering sensor, and wherein a calculation of the volume flow or the mass flow of the fluid is possible by a metering computer based on the metered pressure and temperature values.

Other measurements by sensors may be needed for the calculation of the volume or mass flow, if the physical state of the fluid can change during the measurement. Other metered quantities may be, for example, the density of the fluid, the chemical composition or gas analysis, and other measurements. These measurements need not necessarily take place in the area of the differential pressure transducer, but instead may be retrieved from the process control system of a technical layout making use of the differential pressure transducer.

Furthermore, the differential pressure transducer according to the invention is used for a method for calibrating the measurement by a differential pressure transducer, involving the following steps:
introducing of a metering sensor through at least one of the pressure decrease recesses or through at least one of the coupling recesses,
geometrical surveying of the housing internal surface with the metering sensor,
comparing of the dimensions of the surveyed housing internal surface to a given model of the housing internal surface for a measured geometry of the housing internal surface by a data processing system designed for this,
computing of the correction data for the calibration of the differential pressure transducer and
providing of the correction data for the metering computer of the flow metering device.

This method is made possible only by the differential pressure transducer according to the disclosure. As the metering sensor for the surveying of the housing internal surface, ultrasound or laser metering sensors are proposed, for example. The benefit of the method according to the invention lies in the fact that it is no longer necessary to dismantle a differential pressure transducer in operation in order to survey its housing internal surface. Thus, the calibrations usually required during operation can be done “in situ”. For example, the geometrical surveying of the housing internal surface can thus be done at reduced operating pressure or even under process operating pressure, given appropriate design of the pressure decrease recesses, yet still in the installed state. This represents a sizeable time advantage as compared to the otherwise necessary dismantling of the differential pressure transducer and its connected recording devices and signal lines, as well as possible shutdown of the layout in which the differential pressure transducer is installed.

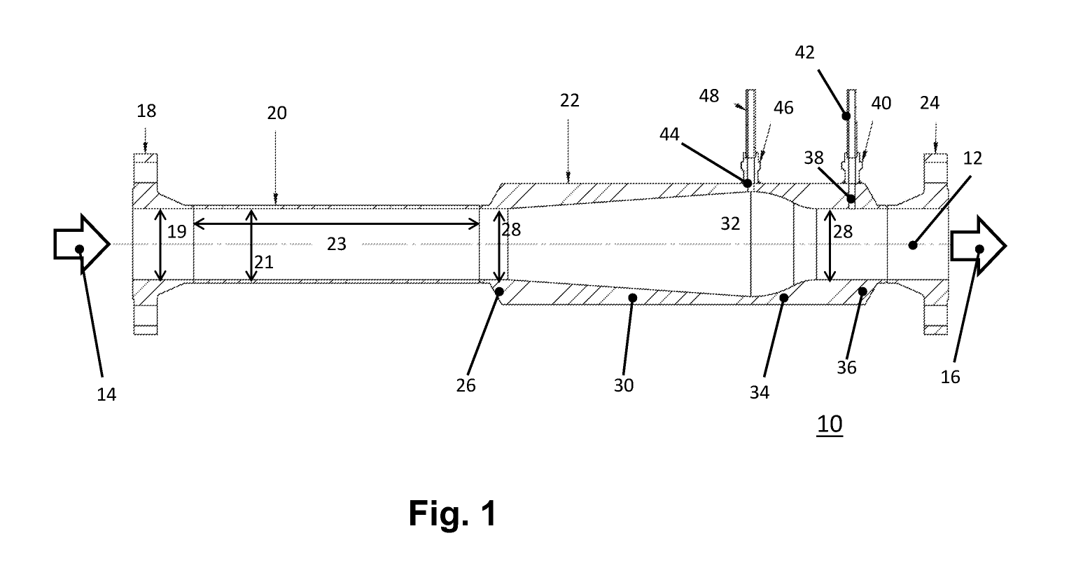

FIG. 1 shows a first differential pressure transducer 10 according to the disclosure with a circular flow cross section in a cross section view through its longitudinal extension. Hence, in the following the inner dimensions or tube inner dimensions are always denoted as diameter. The cross section occurs through a centre axis 12 of the first differential pressure transducer 10 and a flow direction of a fluid through the first differential pressure transducer 10 is indicated by an inflow arrow 14 and an outflow arrow 16. Looking in the flow direction, a fluid at first flows through a first connection element 18, having an inner region inside the tube with a constant internal diameter 19 and configured in the example shown as a screw flange. However, many connection possibilities are conceivable here, such as a welded flange or a glued connection element. The first connection element 18 is connected downstream to a first end of an equalization tube 20, for example by welding, having a constant tube inner diameter 21 and an equalization tube length 23. A second end of the equalization tube 20 is connected to one end of a tubular housing 22, whose other end is connected to a second connection element 24. The second connection element 24 is also configured as a screw flange, however like the first connection element 18 it may also be configured as another connection piece. In the example chosen, the first connection element 18, the equalization tube 20, the housing 22 and the second connection element 24 are made from a steel, preferably from the same material as the pipeline in which the first differential pressure transducer 10 is installed. The choice of the material, however, may also depend on which fluid is going to flow through the first differential pressure transducer, for example, whether it is corrosive or laden with dirt having an abrasive effect. In that case, a material should be chosen having an especially low wear. In this way, the internal geometry of the first differential pressure transducer 10 will have only slight changes during its service life.

The housing 22 may be divided into different sections in its longitudinal extension. At the side where the fluid flows into the housing 22 there is found an inflow section 26, having a constant first inner diameter 28. Corresponding to the first inner diameter 28, the inflow section 26 has a first flow cross section. Downstream from the inflow section 26 there comes a diffuser section 30, whose circular inner diameter increases continuously looking in the flow direction, until a second inner diameter 32 is reached. Corresponding to the increase in the inner diameter in the diffuser section 30, the flow cross section for the fluid increases continuously from the first flow cross section to a second flow cross section, which is reached at the second inner diameter 32. The second inner diameter 32 is also the maximum inner diameter of the housing. Accordingly, the velocity of the medium looking in the flow direction is slowed down and its static pressure component is increased in this place as compared to the region of the first inner diameter 28. Downstream from the diffuser section 28, the housing 22 has a constrictor section 34, also known as the nozzle section, whose inner diameter again decreases continuously from the second inner diameter 32 to the first inner diameter 28. Accordingly, in the outflow section 34, following the constrictor section with the first inner diameter 28, the same flow velocities as in the inflow section 26 obtain.

In the selected example, the ratio between the second inner diameter 32 and the first inner diameter 28 is roughly 1.4 and thus lies within a typical range extending from 1.2 to 2.5. Depending on the fluid, the flow velocity, the diameter of the pipeline, the operating pressure and other boundary conditions, however, this ratio may vary within the indicated range.

In order to achieve advantageous flow conditions in the diffuser section 30, it is proposed that the ratio of the second inner diameter 32 and the length of the diffuser section 30, looking in its longitudinal extension, is between 0.3 and 0.5.

Furthermore, it has been found that the ratio between the length of the diffuser section 30 and the constrictor section 34 also has an influence on the pressure measurement. It has proven to be advantageous for this ratio to be between 0.3 and 0.5.

In the outflow region 36 of the housing 22, a first coupling recess 38 is shown as a borehole through the housing 22. On the outside of the first coupling recess 38 there is mounted a first coupling element 40, whose continuous borehole on the one hand corresponds to the first coupling recess 38 and on the other hand comprises a connection element which is connected to a first impulse line 42 or differential pressure line of a pressure meter or flow meter, not shown in the figure. In this way, it is possible for the pressure measurement to occur through the coupling recess 38 directly at the internal envelope surface of the housing 22 in the outflow section 36. As the pressure transducer for the pressure measurement, many designs can be contemplated, such as a hydraulic U-tube manometer, a single-point pressure transducer, a differential pressure transducer or a combination differential pressure transducer with integrated separate pressure measurement. A comparable layout is possessed by a pressure metering point in the region of the second inner diameter 32. At this point there is arranged in the housing 22 a second coupling recess 44, through which a second coupling element 46 is arranged, whose continuous borehole once again corresponds on the one hand to the second coupling recess 44 and on the other hand has another connection element, to which a second impulse line 48 is attached. Here as well a direct pressure measurement occurs for the pressure in the region of the second inner diameter 32, without this requiring the interpositioning of an otherwise necessary pressure equalization element, such as a pressure equalizing annular space. Moreover, the pressure measurement at only one point on the circumference of the housing 22 in the region of the second inner diameter 32 or in the outflow section 36 is entirely sufficient for the measuring or calculating of pressures or pressure differences. For certain methodological reasons, however, it may be expedient to provide in addition one, two and/or three further coupling recesses along the circumference of the housing at the locations of the first 38 or second coupling recess 44. In this way, a metrological redundancy of, for example, 1 out of 2, 2 out of 3, 2 out of 4 or 3 out of 4 pressure measurements can be realized in an especially easy manner.

Another important influence on the flow in the first differential pressure transducer 10 is exerted by the ratio of the length of the equalization tube 20 to its tube diameter 21, which corresponds to the first inner diameter 28. In the chosen example, this ratio is around 4.2 and thus it lies in a range with which advantageous flow conditions can be dictated in the first differential pressure transducer 10. The minimum length of the equalization tube 20 for a given diameter should have at least the ratio of 2.5, in order to establish favourable flow conditions in the differential pressure transducer for a pressure measurement. This allows for the fact that the length of the first connection element 18 and the length of the first inflow section 26 are added to the length of the equalization tube 20 for the effect on the flow conditions in the differential pressure transducer. In this way, the ratio of the overall length to the tube diameter 21 will usually take on a value of at least 3. Only downstream from the inflow section 26 does the velocity of the fluid begin to slow down on account of the increasing inner diameter in the diffuser section 30.

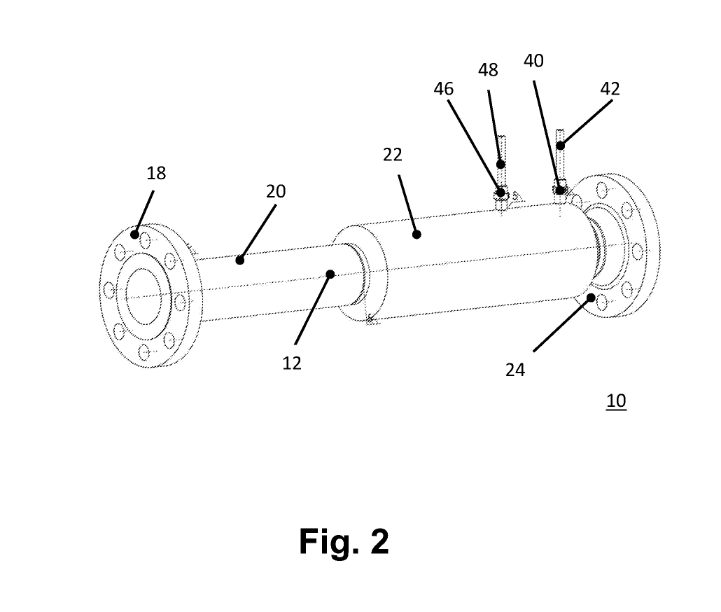

FIG. 2 shows the first differential pressure transducer 10 with its centre axis 12 in a three-dimensional view. It is shown here that the equalization tube 20 and the housing 22 are arranged between the first 18 and the second connection element 24 and can be formed as a metering section with distinct design-dictated length. This means that regardless of where the differential pressure transducer is installed in a pipeline, i.e., for example, directly between two pipe elbows of the pipeline, suitable flow conditions are produced for a pressure measurement thanks to the design of the first differential pressure transducer 10 itself. The design of the outer diameters in the region of the equalization tube 20 and the housing 22 ensures that the direction of installation of the first differential pressure transducer 10 is easily recognizable. The inflow side to the first differential pressure transducer 10 is always the connection side which is closest to the equalization tube 20 with the comparatively small outer diameter. Accordingly, an outflow side of the first differential pressure transducer 10 is the side with the larger outer diameter of the housing 22 or with the coupling elements 40, 46.

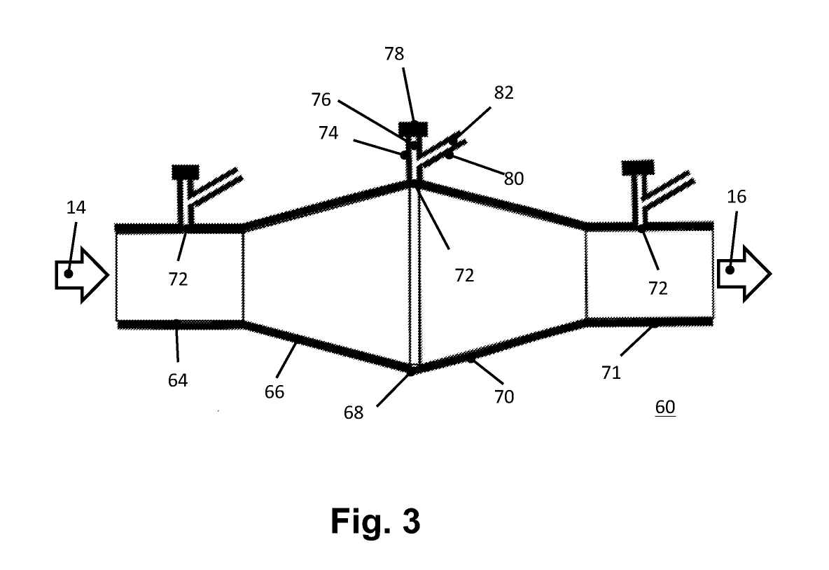

FIG. 3 shows a sketch of a housing piece 60 of a second differential pressure transducer in which the inflow arrow 14 and the outflow arrow 16 show the flow direction through the housing piece 60. The housing piece 60 comprises, in succession in the flow direction, a tubular inflow component 64, a diffuser component 66, a measurement component 68, a constrictor component 70 as well as a tubular outflow component 71. In this embodiment of the housing piece 60 of the second differential pressure transducer according to the invention, the lengths of the diffuser component 66 and the constrictor component 70, i.e., the lengths in the longitudinal extension of the second differential pressure transducer, are the same size. Therefore, it is possible to perform a pressure measurement also in a flow direction which is opposite the indicated flow direction. Furthermore, the housing piece 60 shows a measurement component 68 between the diffuser component 66 and the constrictor component 70, the length of the measurement component 68 in the example shown corresponding to the diameter of a further coupling recess 72. But the length of the measurement component 68 may also be longer, in fact, up to a length corresponding to the inner diameter of the inflow component 64. In the example shown, the housing piece 60 has a total of three further coupling recesses 72, namely, one in the inflow component 64, a second one in the measurement component 68 and a third one in the outflow component 71.

With the help of the sketch, the design of the coupling recesses 72 according to the invention shall now be explained more closely. These have a diameter with which it is possible to introduce a sensor into the internal region of the housing piece 60. Such a sensor is intended, for example, for visual monitoring, or also for surveying of the internal region, it being able to move, rotate or swivel back and forth in the further coupling recess 72 as well as move up and down, so that the largest possible region of the internal region can be surveyed with the sensor. Such measurements need to be performed for calibration purposes at certain intervals of time, in order to verify the measurement results of a differential pressure transducer. One advantage with the differential pressure transducer according to the invention is that it does not need to be dismantled for such measurements from the pipeline, but instead it can be calibrated on the spot, or “in situ”. Furthermore, it is advantageous for this measurement that the second differential pressure transducer 60 has three further coupling recesses 72, namely, one in the inflow component 64, one in the measurement component 68 and one in the outflow component 71. In this way, it is possible for the sensor to perform the surveying of the internal geometry at three different places. Furthermore, the possibility also exists of performing pressure measurements at the three further coupling recesses 72 during the measurement operation of the differential pressure transducer.

The sensor itself may be, for example, an ultrasound metering sensor, a laser metering sensor or an optical sensor, for visual inspection. In the example shown, a coupling component 74 is mounted on the coupling recess 72, the coupling component 74 having a through hole 76, whose one end is brought into flush alignment with the coupling recess 72 and whose other end is closed by an external threaded cap 78. The external threaded cap 78 serves, during the operation of the second differential pressure transducer 60, to close the other end of the coupling component 74. In place of the external threaded cap 78, other closure elements can be screwed on, glued on, or welded on for the closure of the other end, such as internal threaded plugs, flange covers, and clamp covers.

The coupling component 74 has a moulding 80 in which a borehole 82 is introduced, which on the one hand reaches as far as the through hole 76 and on the other hand forms an opening in the moulding 80. This opening is designed so that a pressure metering sensor or an impulse line or a differential pressure line, although not shown in this sketch, can be connected there.

Instead of a closure element, the other end may also be connected and closed with another device. One such device is a cleaning device, for example, for the cleaning of the coupling recess 72, such as a gas pressure cleaning device that works with pressurized air pulses or pressure surges with other gases, a mechanical cleaning device such as a cleaning pin, or an ultrasound cleaning device working with ultrasound impulses. In this way, the coupling recess 72 can be cleared of fouling when necessary, for example when the coupling recess 72 is blocked by contaminants in the fluid, so that a pressure measurement not influenced by contaminants is possible. In the event of heavily contaminated fluids, the periodic cleaning of the coupling recess 72 with the cleaning device is also made possible.

Another possibility for a device is an equalization device, with which the free volume in the differential pressure line can be changed, in particular reduced. The free volume is composed of the free volume of the differential pressure inflow line and the free volume of the recesses in the coupling component 74. An especially simple design of such a device is a pin, which can rotate in the closure element, and which by its rotation is either screwed into or out from the through hole 76, depending on the direction of rotation. In this way, the free volume of the through hole 76 is changed as part of the free volume of the coupling component 74. Such an equalization device can be used to eliminate oscillations whenever oscillations or other perturbations occur in the differential pressure lines.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. A differential pressure transducer through which fluid may flow, the differential pressure transducer comprising:
first and second connection elements;
a tubular housing disposed between the first and second connection elements and arranged such that fluid flows in through the first connection element to the housing and flows out through the second connection element, the housing, as viewed in the direction of fluid flow, comprising:
an inflow section with a first flow cross-section;
a diffuser section following the inflow section, the diffuser section having a flow cross-section increasing continuously up to a second flow cross section;
a constrictor section following the diffuser, the constrictor having a flow cross-section decreasing continuously down to the first flow cross section; and
an outflow section following the constrictor, the outflow section having the first flow cross section; and
wherein the housing, at its circumference, has at least a first pressure decrease recess in the inflow section or in the outflow section and at least a second pressure decrease recess in the vicinity of the second flow cross section; and
an equalization tube connected between the first connection element and the inflow section of the housing, the equalization tube having an inner length and an inner diameter, and wherein a quotient of the inner length and the inner diameter is at least 2.5.

2. The differential pressure transducer according to claim 1, wherein the housing further comprises at least one third pressure decrease recess in the inflow section or in the outflow section, so that the inflow section has one of the first pressure decrease recess and the third pressure decrease recess and the outflow section has the other one of the first pressure decrease recess and the third pressure decrease recess.

3. The differential pressure transducer according to claim 1, wherein a quotient of a second inner diameter of the housing and a first inner diameter of the inflow section is in a range from 1.2 to 2.5.

4. The differential pressure transducer according to claim 3, wherein a quotient of a length of the diffuser section and a length of the constrictor section is in a range from 1 to 5.

5. The differential pressure transducer according to claim 4, wherein a quotient of the second inner diameter of the housing and the length of the diffuser section is in a range from 0.3 to 0.5.

6. The differential pressure transducer according to claim 3, wherein the housing further comprises a metering section interposed between the diffuser section and the constrictor section, the metering section having a diameter that is equal to the second inner diameter and a length that is half of the first inner diameter.

7. The differential pressure transducer according to claim 1, wherein one of the first and second pressure decrease recesses is configured as a coupling recess so as to be suitable for connecting of a coupling element or for introducing of sensors for visual monitoring, geometrical surveying, or calibration of a metrologically relevant region of an interior of the housing.

8. The differential pressure transducer according to claim 7, further comprising a coupling element connected to the housing and interacting with the coupling recess, the coupling element having a connection recess for connection to a pressure metering sensor or a differential pressure line of a pressure metering device.

9. The differential pressure transducer according to claim 8, wherein the connection recess is closed by an external threaded cap, an internal threaded plug, a flange cover, or a clamp cover, or by welding or gluing.

10. The differential pressure transducer according to claim 8, wherein the coupling element has a pair of connection recesses, wherein one of the connection recesses is for connection to a differential pressure line and the other one of the connection recesses is for connection to an equalization device operable to change the free volume in the differential pressure line.

11. The differential pressure transducer according to claim 8, wherein the connection recess is for connection to a cleaning device for cleaning the coupling recess.

12. A flow metering device comprising the differential pressure transducer according to claim 1, and further comprising:
pressure transducers for measuring pressures at the first and second pressure decrease recesses, respectively;
a temperature metering sensor for measuring the temperature of the fluid; and
a metering computer for calculating the volume flow or mass flow of the fluid from the measured pressures and temperature.

13. A method for calibrating the measurement made by a differential pressure transducer according to claim 1, the method comprising:
introducing a metering sensor through one of the first and second pressure decrease recesses;
geometrically surveying an interior surface of the housing with the metering sensor;
using a data processing system to compare the dimensions of the surveyed housing internal surface to a given model of the housing internal surface;
computing correction data for calibration of the differential pressure transducer; and
providing the correction data to a metering computer used with the differential pressure transducer to calculate volume flow or mass flow of the fluid.

14. The differential pressure transducer according to claim 1, wherein a quotient of a second inner diameter of the housing and a first inner diameter of the inflow section is 1.5.

15. The differential pressure transducer according to claim 14, wherein the second inner diameter of the housing is the maximum inner diameter of the housing.

16. The differential pressure transducer according to claim 15, wherein the housing further comprises a metering section disposed between the diffuser section and the constrictor section, the metering section having a diameter that is equal to the second inner diameter.

17. The differential pressure transducer according to claim 1, wherein a quotient of a length of the diffuser section and a length of the constrictor section is in a range from 1 to 5.

18. The differential pressure transducer according to claim 17, wherein the quotient of the length of the diffuser section and the length of the constrictor section is 3.7.
